(19) United States
(12) Patent Application Publication
(10) Pub. No.: US 2005/0095367 A1
(43) Pub. Date: May 5, 2005

(54) Method of noncontact dispensing of viscous material

(76) Inventors: Alec J. Babiarz, Encinitas, CA (US); Liang Fang, San Diego, CA (US); Erik Fiske, Carlsbad, CA (US); Alan Ray Lewis, Carlsbad, CA (US); Horatio Quinones, Carlsbad, CA (US); Greggory Eugene Snowden, Oceanside, CA (US); Terry P. Wilde JR., Temecula, CA (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/699,627

(22) Filed: Oct. 31, 2003

(51) Int. Cl. B05D 1/02

(52) U.S. Cl. 427/421.1

(57) ABSTRACT

A method of noncontact dispensing a viscous material onto a surface of a substrate, which uses a jetting valve having a nozzle directing the viscous material flow in a jetting direction nonperpendicular to the surface of the substrate. The nonperpendicular jetting direction results in the droplet producing a reduced wetted area on the substrate.

### FIELD OF THE INVENTION

The present invention generally relates to the dispensing of viscous materials and more particularly, to a method of noncontact dispensing of droplets of viscous materials.

### BACKGROUND OF THE INVENTION

In the manufacture of substrates, for example, printed circuit (“PC”) boards, it is frequently necessary to apply small amounts of viscous materials, i.e. those with a viscosity greater than fifty centipoise. Such materials include, by way of example and not by limitation, general purpose adhesives, solder paste, solder flux, solder mask, grease, oil, encapsulants, potting compounds, epoxies, die attach pastes, silicones, RTV and cyanoacrylates.

In the quest for ever increasing miniaturization of circuitry, a fabrication process known as flip chip technology has developed, which has multiple processes that require viscous fluid dispensing. For example, as shown in FIG. 8, a device 39, for example, a semiconductor die or chip, is attached to a substrate, such as a PC board 36, via solder balls or pads. In an underfill process, the gap between the chip 39 and the PC board 36 is filled with a viscous liquid epoxy or some other adhesive. Underfilling with the epoxy serves first, as a mechanical bond to help reduce stress and limit strain on the interconnecting solder pads during thermal cycling and/or mechanical loading and second, protects the solder pads from moisture and other environmental effects. The underfill operation deposits liquid epoxy in a more or less continuous manner along at least one side edge of the chip 39. The liquid epoxy can be deposited as a continuous bead or a series of dots applied with a contact needle or a jetting dispenser 40 oriented substantially perpendicular to a major surface 80 of the substrate 36. The liquid epoxy flows under the chip 39 as a result of capillary action due to the small gap between the underside of the chip and the surface 80 of the PC board 36. As liquid epoxy flows under the chip, a wetted area 32 of a thin layer of epoxy remains on the board. The wetted area has two adverse effects. First, the wetted area represents epoxy that is not being used and is wasted. Second, adjacent devices must be located on the PC such that they are outside the wetted area. Therefore, there is a need to provide an underfilling process that minimizes the size of the wetted area on the board.

Once the underfill operation is complete, it is desirable that enough liquid epoxy be deposited to cover all of the electrical interconnections, so that a fillet 35 is formed along the side edges of the chip 39. A properly formed fillet ensures that enough epoxy has been deposited to provide maximum mechanical strength of the bond between the chip and the PC board. It is critical to the quality of the underfilling process that the exact amount of epoxy is deposited at exactly the right location. Too little epoxy can result in corrosion and excessive thermal stresses. Too much epoxy can flow beyond the underside of the chip and interfere with other semiconductor devices and interconnections. Therefore, there is a need to constantly improve the accuracy of material deposition to create a fillet of a desired size.

### SUMMARY OF THE INVENTION

The present invention provides methods of noncontact jetting of a viscous material that reduce a wetted area on a substrate. The methods of the present invention make more efficient use of the dispensed material, which permits more efficient use of the substrate or a reduction in size of the substrate. In addition, by reducing wetted areas, the methods of the present invention provide a potential for greater dispenser velocities, which can reduce dispensing cycle times. Hence, the methods of the present invention are especially useful in performing an underfill operation and can potentially reduce production costs as well as product costs.

The methods of viscous material noncontact jetting of the present invention are also especially useful in those applications where dispensing accuracy and precision are critical.

According to the principles of the present invention and in accordance with the described embodiments, the invention provides a method for noncontact dispensing a viscous material onto a surface of a substrate. The method first provides a jetting valve having a nozzle directing the viscous material flow in a jetting direction nonperpendicular to the surface of the substrate. The jetting process consists of causing the jetting valve to propel a flow of the viscous material through the nozzle with a forward momentum in the jetting direction, breaking the flow of the viscous material using the forward momentum to form a droplet of the viscous material, and applying the droplet of the viscous material to the surface of the substrate using the forward momentum of the droplet. The nonperpendicular jetting direction results in the droplet producing a reduced wetted area on the substrate.

In one aspect of the invention, a positioner supporting the jetting valve is operable to move the jetting valve in a first axis of motion; and the device has a sidewall separated from the surface of the substrate by a gap. The method further comprises orienting the jetting direction oblique to the surface of the substrate and intersecting the substrate at a location in or adjacent to the gap. Then the jetting valve is moved in the first axis of motion with respect to the substrate; and while moving the jetting valve, the steps of causing, breaking, and applying are iterated to apply a linear pattern of viscous material on the substrate adjacent the gap.

In a further aspect of the invention, the positioner is operable to move the jetting valve in a second axis of motion; and the device has first and second sidewalls. The method requires orienting the jetting direction oblique to the surface of the substrate and directed generally toward both the surface of the substrate and the sidewall of the device with a projection of the jetting direction on the substrate being oblique to the first and second sidewalls. Next, the jetting valve is moved in the first axis of motion while the steps of causing, breaking and applying are iterated to apply a linear pattern of viscous material on the substrate adjacent the first sidewall of the device. Thereafter, the jetting valve is moved in the second axis of motion with respect to the substrate while iterating the steps of causing, breaking and applying to apply a linear pattern of viscous material on the substrate adjacent the second sidewall of the device.

In a further embodiment of the invention, the viscous material is a conformal coating material and the method first orients the jetting direction nonperpendicular to the surface of the substrate and intersecting the sidewall of the device. Next, the jetting valve is moved in the first axis of motion with respect to the substrate; and while moving the jetting valve the steps of causing, breaking, and applying are iterated to apply a linear pattern of conformal coating material on the sidewall of the device.

These and other objects and advantages of the present invention will become more readily apparent during the following detailed description taken in conjunction with the drawings herein.

### BRIEF DESCRIPTION OF THE DRAWINGS

FIG. 1 is a schematic representation of a computer controlled, noncontact, viscous material jetting system providing an angled jetting of viscous material in accordance with the principles of the present invention.

FIG. 2 is a schematic block diagram of the computer controlled, noncontact, viscous material jetting system of FIG. 1 with an angled dispenser.

FIG. 3 is a schematic illustration of an underfilling application using the angled nozzle with the computer controlled, noncontact, viscous material jetting system of FIG. 1.

FIG. 4 is a schematic block diagram of the computer controlled, noncontact, viscous material jetting system of FIG. 1 with a dispenser having an angled nozzle.

FIG. 5 is an enlarged cross-sectional view of the angled nozzle that can be used with the noncontact, viscous material jetting system of FIG. 4.

FIG. 6A is a schematic illustration of jetting with a dispenser not having a Z axis rotation.

FIG. 6B is a schematic illustration of jetting with a dispenser with a Z axis rotation.

FIG. 7 is a schematic illustration of a dual jetting application using the angled nozzle with the computer controlled, noncontact, viscous material jetting system of FIG. 1.

FIG. 8 is a schematic illustration of an underfilling application using a known nozzle with a computer controlled, noncontact, viscous material jetting system.

### DETAILED DESCRIPTION OF THE INVENTION

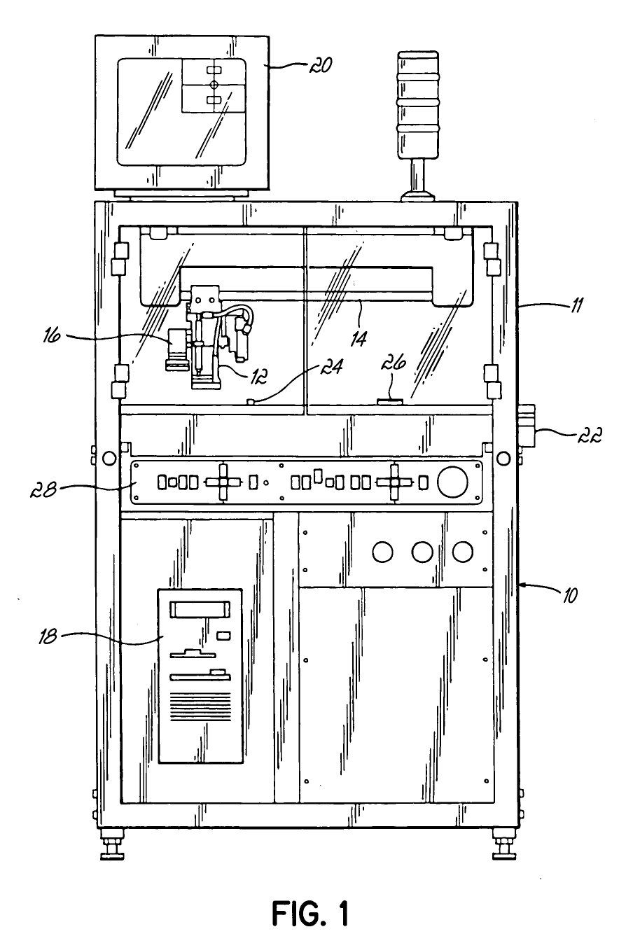

FIG. 1 is a schematic representation of a computer controlled noncontact viscous material jetting system 10, for example, an “AXIOM” X-1020 series commercially available from Asymtek of Carlsbad, Calif. A droplet generator 12 is mounted on a Z axis drive that is suspended from an X, Y positioner 14 in a known manner. The X, Y position 14 is mounted on a frame 11 and defines first and second nonparallel axes of motion. The X, Y positioner includes a cable drive coupled to a pair of independently controllable stepper motors (not shown) in a known manner. A video camera and LED light ring assembly 16 are connected to the droplet generator 12 for motion along the X, Y and Z axes to inspect dots and locate reference fiducial points. The video camera and light ring assembly 16 may be of the type described in U.S. Pat. No. 5,052,338 entitled “APPARATUS FOR DISPENSING VISCOUS MATERIALS A CONSTANT HEIGHT ABOVE A WORKPIECE SURFACE”, the entire disclosure of which is incorporated be reference herein.

A computer 18 provides overall system control and may be a programmable logic controller (“PLC”) or other microprocessor based controller, a hardened personal computer or other conventional control devices capable of carrying out the functions described herein as will be understood by those of ordinary skill. A user interfaces with the computer 18 via a keyboard (not shown) and a video monitor 20. The computer 18 is provided with standard RS-232 and SMEMA CIM communications busses 50 which are compatible with most types of other automated equipment utilized in substrate production assembly lines.

A substrate (not shown) onto which dots of a viscous material, for example, an adhesive, epoxy, solder, etc., are to be applied is located directly beneath a droplet generator 12. The substrate can be manually loaded or transported by an automatic conveyor 22. The conveyor 22 is of conventional design and has a width, which can be adjusted to accept PC boards of different dimensions. The conveyor 22 also includes pneumatically operated lift and lock mechanisms. This embodiment further includes a nozzle priming station 24 and a nozzle calibration set-up station 26. A control panel 28 is mounted on the frame 11 just below the level of the conveyor 22 and includes a plurality of push buttons for manual initiation of certain functions during set-up, calibration and viscous material loading.

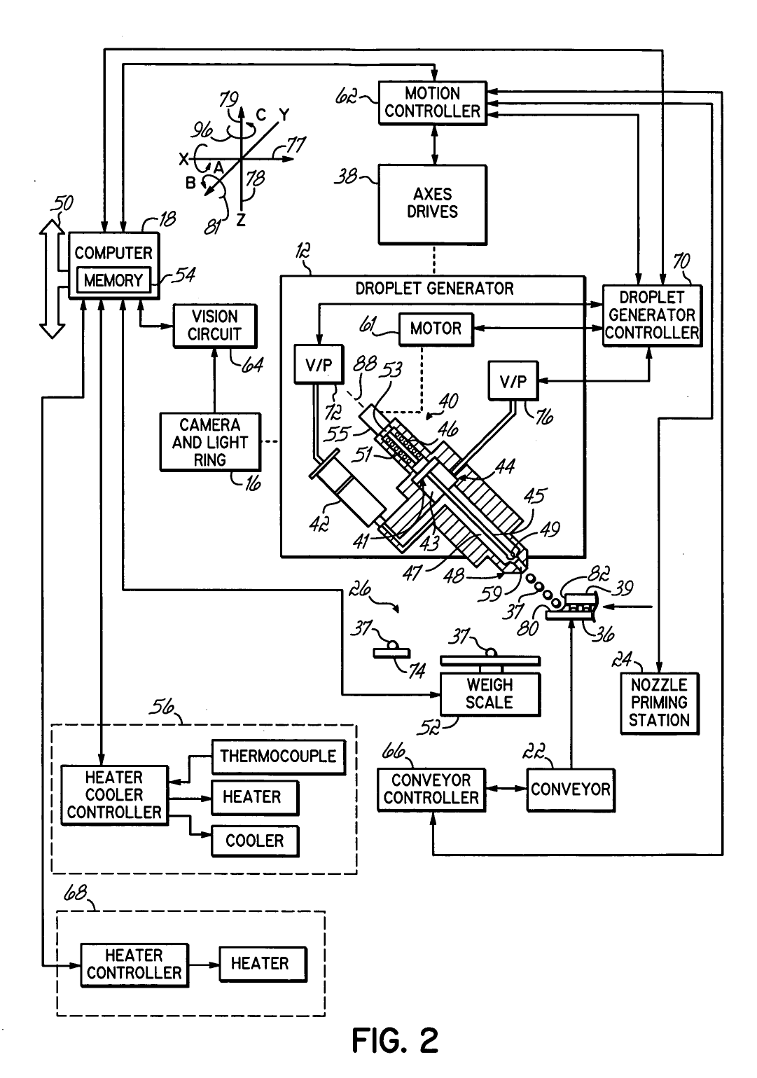

Referring to FIG. 2, the droplet generator 12 is shown ejecting a jet 34 of viscous material onto a substrate 36, for example, a PC board, that supports an electrical device 39, for example, a semiconductor chip or die, etc. The PC board 36 is of the type designed to have components surface mounted thereon utilizing a viscous material placed at desired locations. The PC board is moved to a desired position by the conveyor 22.

The axes drives 38 include the X, Y positioner 14 (FIG. 1) and a Z axis drive system, which are capable of rapidly moving a dispenser 40 along X, Y and Z axes 77, 78, 79, respectively, with respect to the PC board 36. The droplet generator 12 can eject droplets of viscous material from one fixed Z height, or the droplet generator 12 can be raised under program control during a cycle of operation to dispense at other Z heights or to clear other components mounted on the board.

The droplet generator 12 includes an ON/OFF jetting dispenser 40, which is a non-contact dispenser specifically designed for jetting minute amounts of viscous material. The dispenser 40 has a jetting valve 44 with a piston 41 disposed in a cylinder 43. The piston 41 has a lower rod 45 extending therefrom through a material chamber 47. A distal lower end of the lower rod 45 is biased against a seat 49 by a return spring 46. The piston 41 further has an upper rod 51 extending therefrom with a distal upper end that is disposed adjacent a stop surface on the end of a screw 53 of a micrometer 55. Adjusting the micrometer screw 53 changes the upper limit of the stroke of the piston 41. The dispenser 40 may include a syringe-style supply device 42 that is fluidly connected to a supply of viscous material (not shown) in a known manner. A droplet generator controller 70 provides an output signal to a voltage-to-pressure transducer 72, for example, a pneumatic solenoid connected to a pressurized source of fluid, that, in turn, ports pressurized air to the supply device 42. Thus, the supply device 42 is able to supply pressurized viscous material to the chamber 47.

A jetting operation is initiated by the computer 18 providing a command signal to the droplet generator controller 70, which causes the controller 70 to provide an output pulse to a voltage-to-pressure transducer 76, for example, a pneumatic solenoid connected to a pressurized source of fluid. The pulsed operation of the transducer 76 ports a pulse of pressurized air into the cylinder 43 and produces a rapid lifting of the piston 41. Lifting the piston lower rod 45 from the seat 49 draws viscous material in the chamber 47 to a location between the piston lower rod 45 and the seat 49. At the end of the output pulse, the transducer 76 returns to its original state, thereby releasing the pressurized air in the cylinder 43, and a return spring 46 rapidly lowers the piston lower rod 45 back against the seat 49. In that process a jet of viscous material is rapidly extruded or jetted through an opening or dispensing orifice 59 of a nozzle 48. As schematically shown in exaggerated form in FIG. 2, a very small viscous material droplet 37 breaks away as a result of its own forward momentum; and its forward momentum applies it to a surface 80 of the substrate 36 as dot of viscous material on the substrate 36. Successive operations of the cylinder 43 provide respective droplets of viscous material 37. As used herein, the term “jetting” refers to the above-described process for forming the viscous material droplets 37. The dispenser 40 is capable of jetting droplets from the nozzle 48 at very high rates, for example, up to 100 or more droplets per second. A motor 61 controllable by the droplet generator controller 70 is mechanically coupled to the micrometer screw 53, thereby allowing the stroke of the piston 41 to be automatically adjusted, which varies the volume of viscous material forming each droplet.

A motion controller 62 governs the motion of the droplet generator 12 and the camera and light ring assembly 16 connected thereto. The motion controller 62 provides command signals to separate drive circuits for the X, Y and Z axis motors. A conveyor controller 66 is connected to the substrate conveyor 22. The conveyor controller 66 interfaces between the motion controller 62 and the conveyor 22 for controlling the width adjustment and lift and lock mechanisms of the conveyor 22. The conveyor controller 66 also controls the entry of the substrate 36 into the system and the departure therefrom upon completion of the material deposition. In some applications, a substrate heating system 68 and/or a nozzle heating/cooling system 56 are operative in a known manner to heat the substrate and/or nozzle to maintain a desired temperature profile of the viscous material as the substrate is conveyed through the system.

The nozzle setup station 26 is used for calibration purposes to provide a dot size calibration for accurately controlling the weight or size of the dispensed droplets 37 and a dot placement calibration for accurately locating viscous material dots that are dispensed on-the-fly, that is, while the droplet generator 12 is moving relative to the substrate 36. In addition, the nozzle setup station is used to provide a material volume calibration for accurately controlling the velocity of the droplet generator 12 as a function of current material dispensing characteristics, the rate at which the droplets are to be deposited and a desired total volume of viscous material to be dispensed in a pattern of dots. The nozzle setup station 26 includes a stationary work surface 74 and a measuring device 52, for example, a weigh scale that provides a feedback signal to the computer 18 representing the weight of material weighed by the scale 52. Weigh scale 52 is operatively connected to the computer 18, which is capable of comparing the weight of the material with a previously determined specified value, for example, a viscous material weight setpoint value stored in a computer memory 54. Other types of devices may be substituted for the weigh scale 24 and, for example, may include other dot size measurement devices such as vision systems, including cameras, LEDs or phototransistors for measuring the diameter, area and/or volume of the dispensed material. Prior to operation, a nozzle assembly is installed that is often of a known disposable type designed to eliminate air bubbles in the fluid flow path. Such a dispensing system is more fully described in pending provisional application Ser. No. 60/473,1616, entitled “Viscous Material Noncontact Dispensing System”, filed May 23, 2003, which is hereby incorporated by reference in its entirety herein.

In operation, CAD data from a disk or a computer integrated manufacturing (“CIM”) controller are utilized by the computer 18 to command the motion controller 62 to move the droplet generator 12. This ensures that the minute dots of viscous material are accurately placed on the substrate 36 at the desired locations. The computer 18 automatically assigns dot sizes to specific components based on the user specifications or component library. In applications where CAD data is not available, the software utilized by the computer 18 allows for the locations of the dots to be directly programmed. In a known manner, the computer 18 utilizes the X and Y locations, the component types and the component orientations to determine where and how many viscous material dots to deposit onto the upper surface of the substrate 36.

Known jetting dispensers direct the viscous material in a jetting direction that is substantially perpendicular to the substrate 36; however, with one embodiment of the present invention, as shown in FIG. 2, the jetting dispenser 40 is mounted to be pivotable about the Y axis 78. The jetting dispenser 40 uses a known straight jetting nozzle, which ejects viscous material in a direction substantially parallel to a centerline 88 of the dispenser 40. However, the angled mounting of the dispenser 40 results in the viscous material droplets 37 being jetted in a jetting direction that is nonperpendicular to the upper surface 80 of the substrate 36. Such angled jetting can be used in many applications where viscous materials are used in the process of mounting components on a substrate or in applying one or more conformal coatings to a substrate having components assembled thereon.

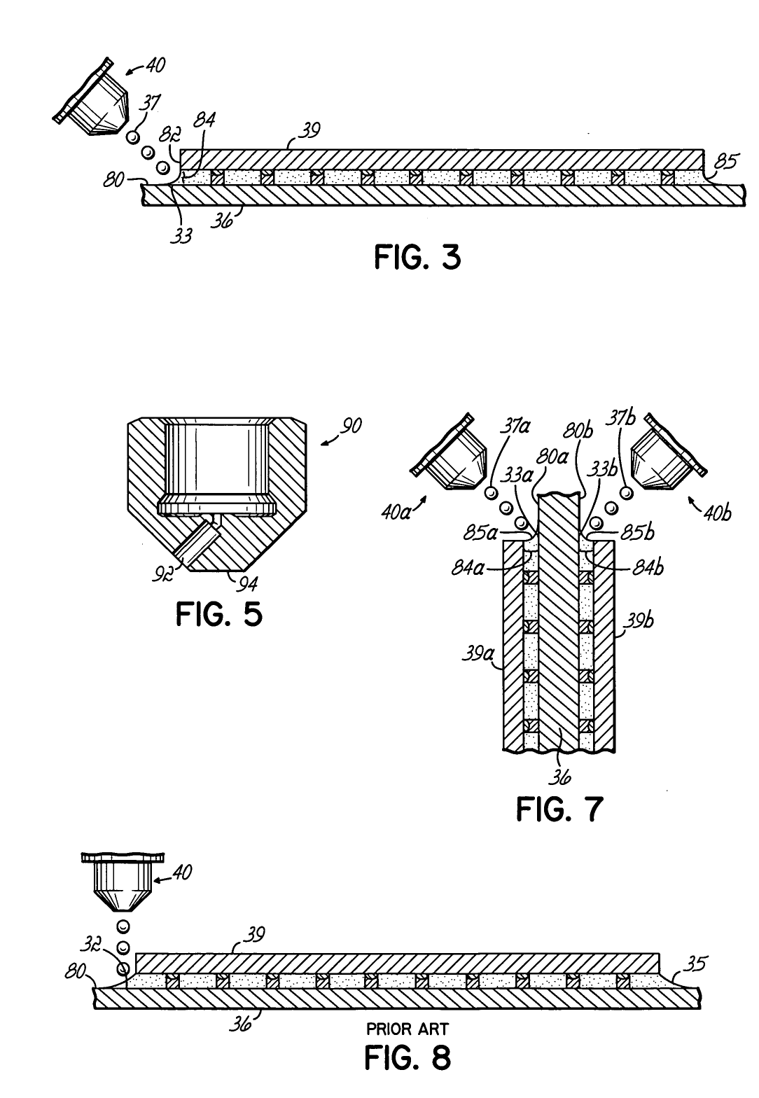

For example, in an underfilling operation shown in FIG. 3, the droplets 37 are jetted in a direction that is oblique to the upper surface 80 of the substrate 36 and deposited immediately adjacent a gap or space 84 below a sidewall 82 of the chip 39. The angled or oblique jetting creates a force of impact at a corner formed by the gap 84 and the surface 80, which helps to prevent the viscous material from spreading over the surface 80. Thus, the angled jetting produces a smaller wetted area than known jetting in which the impact force occurs in direction perpendicular to the surface 80 as shown in FIG. 8. Further, the speed of the jetting process permits multiple passes to be made, so that additional material can be layered as previously deposited material moves under the component via capillary action. In addition, final passes can be made to form a fillet 85 of the desired size while continuing to keep the wetted area to a minimum.

The desired angle of the jetting direction is application dependent. For example, in an underfilling operation, the jetting direction may be at an angle that is in a range of about 10-80 degrees with respect to the upper surface 80 of the substrate 36. In another application, it is desirable to apply a viscous material to a vertical substrate, for example, a vertical sidewall 82 of the chip 39; and in such application, the jetting direction may be at an angle that is in a range of about 80-100 degrees with respect to the chip sidewall 82.

In use, an optimum angle can be determined in a preproduction jetting cycle during which the viscous material is dispensed with the dispenser 40 mounted at different angles, which are changed by manual adjustments. Based on measurements of the wetted area and other qualitative indicators resulting from jetting at different angles, an optimum angle or range of angles can be determined and recorded. Once a desired jetting angle is determined, during a production cycle, the computer 18 provides output signals to the motion controller 26 causing the motion controller to initiate motion of the dispenser 40 along a first axis of motion, for example, a Y axis of motion as shown in FIG. 2. Simultaneously with that motion, the motion controller operates the jetting valve 40 in a manner as previously described to apply droplets of the viscous material onto the substrate surface 80 in a linear pattern.

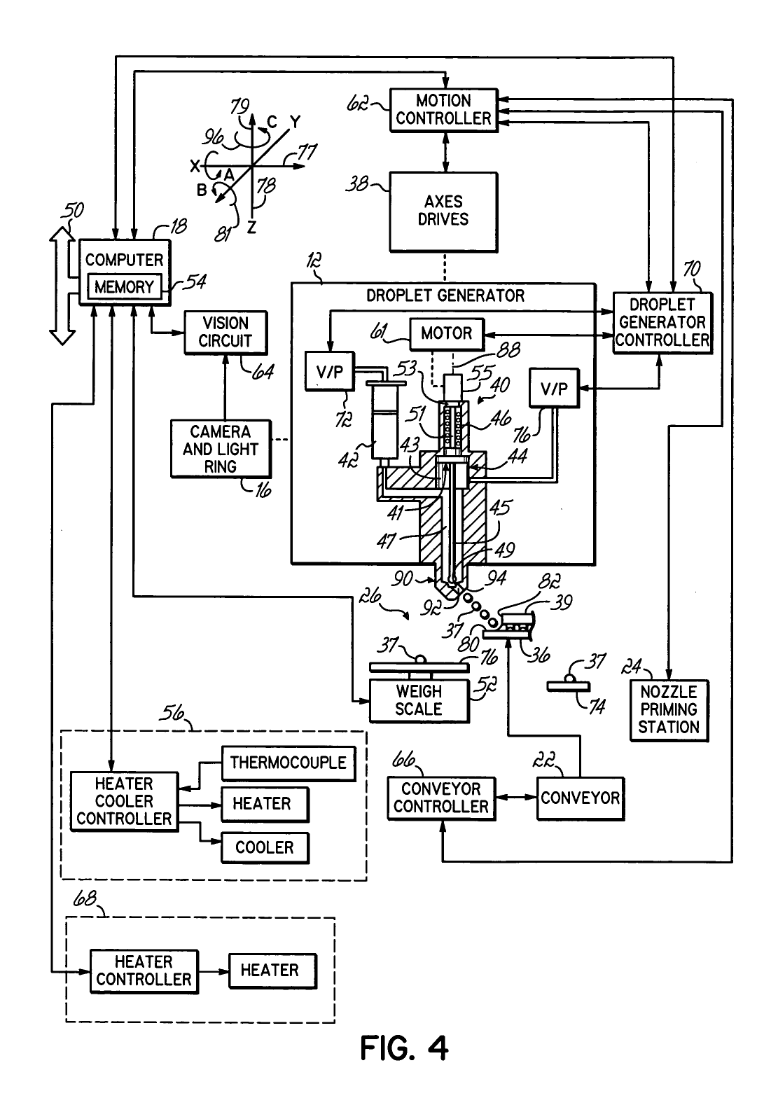

In addition to rotatably mounting the jetting dispenser 40 at an angle, other structures can be used to provide an angular jetting direction that is nonperpendicular with the substrate surface 80. For example, in another embodiment shown in FIGS. 4 and 5, an angled nozzle 90 is mounted on the end of the dispenser 40. The angled nozzle 90 has an angled exit passage that terminates with an opening or dispensing orifice 92 in a side wall 94. The exit passage often has a length that is two or three times a diameter of the dispensing orifice 92. Further, the exit passage can be cylindrical with straight walls, or it can be tapered toward the dispensing orifice 92. The diameter of the dispensing orifice 92 is application dependent, and the optimum configuration and dimensions of the angled nozzle 90 are often determined by experimentation. With the angled nozzle 90, viscous material is ejected at an angle with respect to, or in a jetting direction that is nonperpendicular to upper substrate surface 80. Once a desired jetting angle has been determined experimentally, for example, by performing a jetting process with the dispenser 40 rotated at different angles as described above, the angled nozzle 90 can be made to jet material at the desired jetting angle.

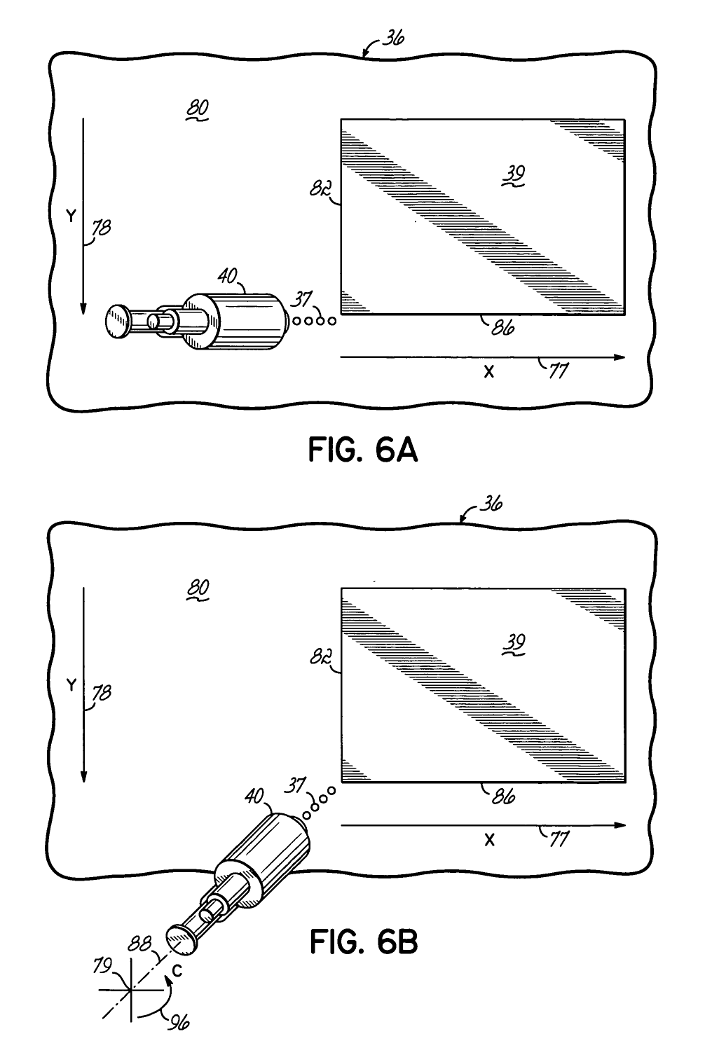

In many applications, it is desirable to apply the viscous material along two mutually perpendicular sides of a component. With the angular jetting described with respect to FIG. 2, the jetting direction is directed downward toward the substrate, that is, pivoted in a first angular B axis 81 that provides a rotation about the Y axis 78, such that it intersects the upper surface 80 adjacent a first sidewall 82. With that jetting angle, as shown in FIG. 6A, a projection of the jetting direction onto the substrate upper surface 80, as generally represented by the droplets 37, is substantially perpendicular to the first sidewall 82 and substantially parallel to the sidewall 86. Therefore, moving the dispenser 40 along the Y axis 78 permits viscous material 37 to be jetted onto the surface 80 in a linear pattern immediately adjacent the sidewall 82. However, upon reaching an intersection between the sidewalls 82 and 86, the dispenser 40 is not properly oriented to angularly jet material with respect to the sidewall 86. Jetting viscous material along sidewall 86 with the orientation shown in FIG. 6A produces results comparable to the known jetting that is perpendicular to the substrate 36. To achieve the desired jetting angle that was used with respect to the sidewall 82, the jetting dispenser 40 must be pivoted in a second angular C axis 79 that provides a rotation about the Z axis 79.

In a still further embodiment, referring to FIG. 6B, the dispenser 40 is mounted on the Z axis positioner to be further rotatable in the C axis 96. Rotation of the jetting dispenser 40 in the C axis causes a projection of the jetting direction on the substrate surface 80, as generally represented by the droplets 37, to be oblique to both the sidewall 82 and the sidewall 86. Further, the jetting dispenser 40 is pivoted in both the B axis and the C axis such that the jetting direction is at the desired angles; and the jetting direction intersects Therefore, moving the dispenser 40 along the Y axis 78 permits jetted droplets 37 to be applied jetted onto the surface 80 in a linear pattern immediately adjacent the sidewall 82. Further, when it reaches the intersection of the sidewalls 82 and 86, with the C axis rotation, as the dispenser 40 is moved along the X axis 77, droplets of viscous material are jetted onto the substrate surface 80 immediately adjacent the sidewall 86. Thus, by initially pivoting the jetting dispenser 40 at fixed angles in the B and C axes, viscous material droplets can be jetted along two mutually perpendicular sidewalls 82, 86 by simply moving the dispenser 40 first along the Y axis 78 and then the X axis 77.

In the described embodiments, the angular motions are manually adjustable, however, as will be appreciated, electric or fluid motors can be used to power one or both of the angles of rotation that are used to set the jetting direction at an angle. Further, the electric and fluid motors can be placed under program control of the computer 16 or the motion controller 26. An example of a dispensing system having a first programmable axis of angular motion about a Z axis and a second programmable axis of angular motion about an axis perpendicular to the Z axis is shown and described in U.S. Pat. No. 6,447,847, which is hereby incorporated by reference in its entirety herein. U.S. Pat. No. 5,141,165 relates to a dispenser having a programmable axis of angular motion about a Z axis, wherein the dispenser has a nozzle that is pivotable about a programmable axis of angular motion perpendicular to the Z axis. U.S. Pat. No. 5,141,165 is hereby incorporated by reference in its entirety herein.

It is also known to provide multiple dispensers on one or more positioners in order to simultaneously dispense a viscous material. In another embodiment shown in FIG. 7, dispensers 40a, 40b are used to jet respective streams of droplets 37a, 37b onto respective opposite surfaces 80a, 80b of a substrate 36. By jetting at an angle, the droplets 37a, 37b are aimed into corners adjacent respective gaps 84a, 84b adjacent respective sidewalls 82a, 82b of respective devices 39a, 39b. As previously described, the angled jetting reduces wetted surfaces 33a, 33b on the respective surfaces 80a, 80b not only during an underfilling process but also in the formation of respective fillets 85a, 85b.

In still further applications, the angle of the jetting direction can be changed between passes, which may help maintain a minimal wetted area. For example, after an underfilling operation, one or more additional passes may be made to form a fillet 85 (FIG. 3) in order to properly cover the electrical interconnections. In some applications, it may be desirable to decrease the jetting angle with respect to the substrate surface 80 and increase the jetting angle with respect to the sidewall 82, this is, pivot the jetting direction to be slightly closer to a perpendicular to the sidewall 82. Thus, the impact force of jetting the droplets more against the sidewall 82 helps to layer the fillet up along the sidewall 82, thereby reducing the wetted area 33 on the substrate surface 80.

Jetting the viscous material at an angle to the substrate 36 has many advantages. First, jetting the droplets 37 increases the accuracy and repeatability with which the viscous material can be applied into a corner area between a substrate surface 80 and a chip sidewall 82. Further, with the impact forces of the droplets 37 directed into the corner adjacent the gap 84, the wetted area of the viscous material on the substrate 80 is reduced. A smaller wetted area provides a potential for increased device density on the substrate 36 and thus, making the substrate smaller. In addition, increasing the speed at which the dispenser 40 is moved by the positioner 14 often results in an increase in the wetted area. By jetting at an angle, the positioner speed can be increased without increasing the size of the wetted area when compared to nonangular jetting. Therefore, potentially the cycle time for an underfill process can be shortened, thereby reducing costs. Further, the greater viscous material deposition accuracy and repeatability also often means that less viscous material will be used, which also translates into a savings in cost.

While the invention has been illustrated by the description of one embodiment and while the embodiment has been described in considerable detail, there is no intention to neither restrict nor in any way limit the scope of the appended claims to such detail. Additional advantages and modifications will readily appear to those who are skilled in the art. For example, in the described embodiment, in FIG. 2, the dispenser is shown rotated about the Y axis 78 to provide a desired angled jetting direction. As will be appreciated, in other embodiments, the dispenser may be mounted at a right angle to the mounting shown in FIG. 7; and in that embodiment, the dispenser would be rotated about the X axis 77 to obtain a desired jetting angle.

In the described embodiments, the device 39 is shown as having sidewalls 82, 86 substantially perpendicular to the substrate surface 80; however, as will be appreciated, in other applications, one or more of the device sidewalls can be nonperpendicular, curved or some other shape. In addition, the positioner 14 is shown and described as having two mutually perpendicular and linear axes of motion. Again, as will be appreciated, in other applications, the one or more axes of motion of the positioner can be nonlinear.

In the described embodiments, the application of a viscous material is shown in applications relating to the mounting of devices 39 on a substrate 36, such as, underfilling and forming a substrate. As will be appreciated, in various embodiments shown and described herein for jetting a viscous material at an angle can also be used to apply a conformal coating to the device 39 and/or substrate 36. For example, referring to FIG. 3, the dispenser 40 can be pivoted at a desired angle to jet droplets 37 of a conformal coating material onto the sidewall 82.

Therefore, the invention in its broadest aspects is not limited to the specific details shown and described. Consequently, departures may be made from the details described herein without departing from the spirit and scope of the claims, which follow.

1. A method of noncontact dispensing a viscous material onto a surface of a substrate, the method comprising:
providing a jetting valve having a nozzle directing the viscous material flow in a jetting direction nonperpendicular to the surface of the substrate;
causing the jetting valve to propel a flow of the viscous material through the nozzle with a forward momentum in the jetting direction;
breaking the flow of the viscous material using the forward momentum to form a droplet of the viscous material; and
applying the droplet of the viscous material to the surface of the substrate, a wetted area on the substrate produced by the droplet being reduced by the jetting direction being nonperpendicular to the surface of the substrate.

2. The method of claim 1 further comprising:
providing a positioner supporting the jetting valve and being operable to move the jetting valve in a first axis of motion;
moving the jetting valve in the first axis of motion with respect to the substrate; and simultaneously,
iterating the steps of causing, breaking and applying to apply a pattern of the viscous material to the substrate.

3. The method of claim 2 wherein the first axis of motion is a linear axis of motion and the pattern of the viscous material on the substrate is a linear pattern.

4. The method of claim 2 wherein the substrate supports a device having a sidewall separated from the surface of the substrate by a gap, the sidewall being nonparallel to the surface of the substrate and substantially parallel to the first axis of motion, the method further comprising:
orienting the jetting direction oblique to the surface of the substrate and intersecting the substrate at a location in or adjacent to the gap;
moving the jetting valve in the first axis of motion with respect to the substrate; and while moving the jetting valve,
iterating the steps of causing, breaking and applying to apply a linear pattern of viscous material on the substrate adjacent the gap.

5. The method of claim 2 wherein the viscous material is a conformal coating material and the device has a sidewall nonparallel to the surface of the substrate and substantially parallel to the first axis of motion, the method further comprising:
orienting the jetting direction nonperpendicular to the surface of the substrate and intersecting the sidewall of the device;
moving the jetting valve in the first axis of motion with respect to the substrate; and while moving the jetting valve,
iterating the steps of causing, breaking and applying to apply a linear pattern of conformal coating material on the sidewall of the device.

6. The method of claim 2 wherein the device has a sidewall nonparallel to the surface of the substrate and substantially parallel to the first axis of motion, the method further comprising:
orienting the jetting direction oblique to the surface of the substrate and directed generally toward both the surface of the substrate and the sidewall of the device with a projection of the jetting direction on the surface of the substrate being substantially perpendicular to the sidewall of the component;
moving the jetting valve in the first axis of motion with respect to the substrate; and while moving the jetting valve, iterating the steps of causing, breaking and applying to apply a linear pattern of viscous material on the substrate adjacent the sidewall of the device.

7. The method of claim 4 wherein the sidewall of the device is substantially perpendicular to the surface of the substrate.

8. The method of claim 2 wherein the positioner is operable to move the jetting valve in a second axis of motion nonparallel to the first axis of motion and the substrate has a device mounted thereon with a first sidewall nonparallel to the surface of the substrate and substantially parallel to the first axis of motion, the device further having a second sidewall nonparallel to the surface of the substrate and substantially parallel to the second axis of motion, the method further comprising:
orienting the jetting direction oblique to the surface of the substrate and directed generally toward both the surface of the substrate and the sidewall of the device with a projection of the jetting direction on the substrate being oblique to the first and second sidewalls;
moving the jetting valve in the first axis of motion with respect to the substrate;
simultaneously moving the jetting valve and iterating the steps of causing, breaking and applying to apply a linear pattern of viscous material on the substrate adjacent the first sidewall of the device;
thereafter, moving the jetting valve in the second axis of motion with respect to the substrate;
and while moving the jetting valve in the second axis of motion,
iterating the steps of causing, breaking and applying to apply a linear pattern of viscous material on the substrate adjacent the second sidewall of the device.

9. The method of claim 6 wherein the first sidewall and the second sidewall are substantially perpendicular to the surface of the substrate.

10. The method of claim 2 further comprising:
orienting the jetting direction at a first angle with respect to the surface of the substrate;
moving the jetting valve in the first axis of motion with respect to the substrate; while moving the jetting valve,
iterating the steps of causing, breaking and applying to apply a linear pattern of viscous material to the substrate;
orienting the jetting direction at a second angle with respect to the surface of the substrate;
moving the jetting valve in the first axis of motion with respect to the substrate; and while moving the jetting valve,
iterating the steps of causing, breaking and applying to apply a linear pattern of viscous material to the substrate.

11. A method of noncontact dispensing a viscous material onto first and second opposed surfaces of a substrate, the method comprising:
providing a first jetting valve having a first nozzle directing a first viscous material flow in a first jetting direction nonperpendicular to the first surface of the substrate;
causing the first jetting valve to propel a first flow of the viscous material through the first nozzle with a forward momentum in the first jetting direction;
breaking the first flow of the viscous material using the forward momentum to form a first droplet of the viscous material;
applying the first droplet of the viscous material to the first surface of the substrate;
providing a second jetting valve having a second nozzle directing a second viscous material flow in a second jetting direction nonperpendicular to the second surface of the substrate;
causing the second jetting valve to propel a second flow of the viscous material through the second nozzle with a forward momentum in the second jetting direction;
breaking the second flow of the viscous material using the forward momentum to form a second droplet of the viscous material; and
applying the second droplet of the viscous material to the second surface of the substrate.

12. The method of claim 11 wherein the steps of causing the first jetting valve and causing the second jetting valve occur substantially simultaneously.

13. A method of noncontact dispensing a conformal coating material onto a device supported on a surface of a substrate, the method comprising:
providing a jetting valve having a nozzle directing the conformal coating material flow in a jetting direction nonperpendicular to the surface of the substrate and directed toward the device;
causing the jetting valve to propel a flow of the conformal coating material through the nozzle with a forward momentum in the jetting direction;
breaking the flow of the conformal coating material using the forward momentum to form a droplet of the viscous material; and
applying the droplet of the conformal material to the device.

14. A method of noncontact dispensing a viscous material onto a surface of a substrate having a device mounted thereon with first and second sidewalls being nonparallel with the surface of the substrate, the method comprising:
providing a positioner supporting a jetting valve having a nozzle directing a viscous material flow in a jetting direction, the positioner being operable to move the jetting valve along X, Y and Z axes of motion, the X and Y axes of motion being substantially parallel to the respective first and second sidewalls, the jetting valve being pivotable in a first angular axis of motion rotatable about the Z axis of motion and a second angular axis of motion rotatable about one of the X and Y axes of motion;
orienting the jetting direction oblique to the surface of the substrate and intersecting the substrate at a location adjacent the first sidewall with a projection of the jetting direction on the substrate being oblique to the first and second sidewalls;
moving the jetting valve along the X axis of motion; and while moving the jetting valve in the X axis of motion,
creating droplets of viscous material by iteratively
causing the jetting valve to propel a flow of the viscous material through the nozzle with a forward momentum in the jetting direction,
breaking the flow of the viscous material using the forward momentum to form a droplet of the viscous material, and
applying the droplet of the viscous material to the surface of the substrate adjacent the first sidewall, a wetted area on the substrate produced by the droplet being reduced by the jetting direction being oblique to the substrate.

15. The method of claim 14 further comprising:
moving the jetting valve along the Y axis of motion; and while moving the jetting valve along the Y axis of motion,
creating droplets of viscous material by iteratively
causing the jetting valve to propel a flow of the viscous material through the nozzle with a forward momentum in the jetting direction,
breaking the flow of the viscous material using the forward momentum to form a droplet of the viscous material, and
applying the droplet of the viscous material to the surface of the substrate adjacent the first sidewall.

16. A method of noncontact dispensing a viscous material onto a surface of a substrate comprising:
providing a positioner supporting the jetting valve having a nozzle directing a flow of viscous material flow in a jetting direction, the positioner being operable to move the jetting valve in a first axis of motion, and the jetting valve being pivotable on the positioner;
pivoting the jetting valve to orient the jetting direction nonperpendicular to the surface of the substrate;
causing the jetting valve to propel a flow of the viscous material through the nozzle with a forward momentum in the jetting direction;
breaking the flow of the viscous material using the forward momentum to form a viscous material droplet; and
applying the viscous material droplet to the surface of the substrate, a wetted area on the substrate produced by the viscous material droplet being reduced by the jetting direction being nonperpendicular to the substrate.

17. The method of claim 16 wherein the first axis of motion is a linear axis of motion and the jetting valve is pivotable about an angular axis of motion rotatable about the first axis of motion.

18. A method of noncontact dispensing a viscous material onto a surface of a substrate comprising:
providing a jetting valve having a nozzle with an angled exit passage directing the material flow in a jetting direction nonperpendicular to the substrate without having to pivot the nozzle;
causing the jetting valve to propel a flow of viscous material through the nozzle with a forward momentum in the jetting direction;
breaking the flow of the viscous material using the forward momentum to form a viscous material droplet; and
applying the viscous material droplet to the surface of the substrate using the forward momentum of the viscous material droplet, a wetted area on the substrate produced by the viscous material droplet being reduced by the jetting direction being nonperpendicular to the substrate.

19. A method of noncontact dispensing a viscous material onto a surface of a substrate comprising:
providing a jetting valve having a nozzle directing the material flow in a jetting direction;
pivoting the nozzle to orient the jetting direction of the material flow nonperpendicular to the substrate;
causing the jetting valve to propel a flow of viscous material through the nozzle with a forward momentum in the jetting direction;
breaking the flow of the viscous material using the forward momentum to form a viscous material droplet; and
applying a viscous material droplet to the surface of the substrate, a wetted area on the substrate produced by the viscous material droplet being reduced by the jetting direction being oblique to the substrate.
